(19) United States
(12) Patent Application Publication
(10) Pub. No.: US 2004/0019791 A1
(43) Pub. Date: Jan. 29, 2004

(54) Code for object identification

(75) Inventor: Garry R. Whyte, Aurora, OR (US)

Correspondence Address: MARGER JOHNSON & McCOLLOM, P.C., 1030 S.W. Morrison Street, Portland, OR, 97205, US

(73) Assignee: Congruence, LLC, Aurora, OR

(21) Appl. No.: 10/624,872

(22) Filed: Jul. 21, 2003

Related U.S. Application Data
(60) Provisional application No. 60/398,432, filed on Jul. 24, 2002.

(51) Int. Cl. G06F 17/60

(52) U.S. Cl. 713/179; 705/22

(57) ABSTRACT

Codes are randomly generated for objects. There is no relationship between the object and the code assigned to the object. The only meaning to the code is in the association between the code and the object in a database. The service supports requests for new codes for objects, and for inquiries about codes (either existing or not). An inquiry about a code returns information stored in the database associated with an object associated with the code.

### RELATED APPLICATION DATA

This invention claims priority from U.S. Provisional Patent Application Serial No. 60/398,432, filed Jul. 24, 2002.

### FIELD OF THE INVENTION

This invention pertains to codes, and more particularly to codes that can be assigned to objects, to enable product tracking and information flow, among other uses.

### BACKGROUND OF THE INVENTION

Before cash registers, merchants had intimate knowledge about their customers. Merchants and customers knew each other. Customers knew what kind of products and quantities the merchants offered, the price levels for the products, and the level of skill and knowledge of the staff. Merchants, on the other hand, knew the kind of products that customers liked, the quantities in which they would purchase, the frequency of purchases, and so on. The merchants could then pass to product manufacturers information about the customers, allowing the manufacturers to customize, at least in part, their products for distinct customers (or at least, distinct localities).

The 20^{th} Century, and the industrial age were in large part responsible for the loss of this mutual knowledge. Customers still knew much about the merchants, but the merchants knew little about their customers. Today, customers hear about sales from advertisements, go to the merchants, and purchase the products. Merchants see far too many customers to keep track of them individually. And because the customers learn about the products outside the store, the merchant does not learn about the customer's likes and dislikes.

In addition, it can be difficult to track a product from its source to its eventual use. For example, a buyer might want to be sure that the corn he purchases is strictly organic corn, grown without pesticides. But before the buyer receives the corn, it travels from the fields to elevators, then is shipped by rail to the buyer, sometimes thousands of miles from the grower. By the time the corn is received, the buyer has no guarantee that the corn he receives is the corn he paid for (other than the assurances of the grower, the elevator operator, and the shipper). The buyer might test the corn and detect some pesticide residue. But is the residue because the grower used pesticides in violation of the contract? Was the buyer's corn mixed with another grower's corn in an elevator by the elevator operator? Or was the buyer's corn diverted by the freight company, either accidentally or intentionally? (If the freight company intentionally delivers the corn to someone other than the buyer, the crime is called “diversion.”) Currently, the buyer has no way to figure out what happened.

Another problem manufacturers face is counterfeiting. “Counterfeiting” is where a third party attempts to pass off their products as the genuine manufacturer's products. Some products are relatively inexpensive to produce, such as shirts. A criminal would have to produce many thousands of shirts to make a profit, because of their relatively low profit margin. But without any way to determine who is producing the shirts, the legitimate manufacturer has no effective way to encourage its customers to purchase the genuine article.

A need remains for a way to label goods that addresses these and other problems associated with the prior art.

### SUMMARY OF THE INVENTION

The invention is a method and apparatus for associating codes with objects. A client of the service requests a code for an object. The service generates a code for the object. The code is then transmitted to the service client, who can mark the object with the code. The code and object identifier are associated with each other in a registry. Downstream users of the object can then make inquiries of the service to learn about the object, and to provide additional information about the object.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a computer equipped to generate codes for objects and respond to inquiries about codes, according to an embodiment of the invention.

FIG. 2 shows details of the database of FIG. 1.

FIG. 3 shows a manufacturer etching codes generated by the computer of FIG. 1 on objects.

FIG. 4 shows a customer making an inquiry about a code from the computer of FIG. 1.

FIG. 5 shows another customer making an inquiry about another code from the computer of FIG. 1.

FIG. 6 shows how the database of FIG. 1 might look in the situation of FIG. 5.

FIG. 7 shows a form used by a client of the computer of FIG. 1 to generate a new code.

FIG. 8 shows a form used by a customer to inquire from the computer of FIG. 1 about a code.

FIG. 9 shows a code generated by the computer of FIG. 1 used in a coupon.

FIGS. 10A-10C show a flowchart of the procedure used by the computer of FIG. 1 to generate a code for an object.

FIGS. 11A-11C show a flowchart of the procedure used by the computer of FIG. 1 to process an inquiry about a code for an object.

FIG. 12 shows a flowchart of the procedure used by a client of the computer of FIG. 1 to request a code for an object.

FIGS. 13A-13B show a flowchart of the procedure used by a customer to inquire from the computer of FIG. 1 about a code for an object.

### DETAILED DESCRIPTION OF THE PREFERRED EMBODIMENT

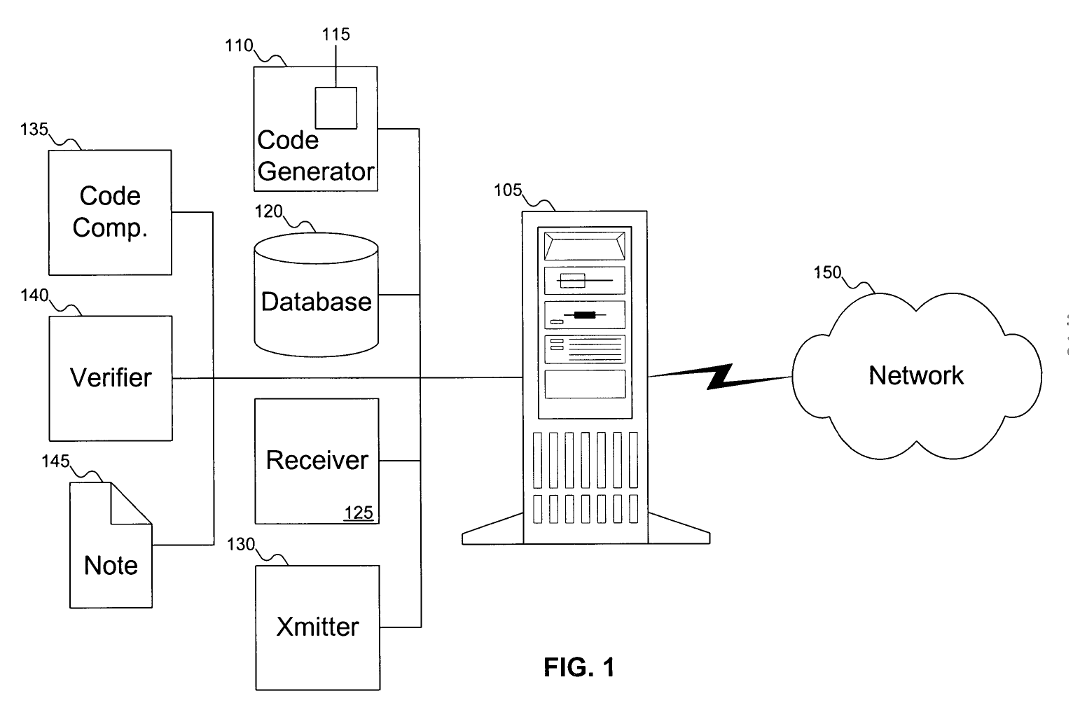

FIG. 1 shows a computer equipped to generate codes for objects and respond to inquiries about codes, according to an embodiment of the invention. In FIG. 1, computer 105 includes conventional components, such as a central processing unit, memory, network interface card, etc. But a person skilled in the art will recognize that not all conventional components might be needed, or can be provided in different ways. For example, the network interface can be built into a motherboard, rather than being a stand-alone card. FIG. 1 does not show other elements that, in combination with computer 105, make up a computer system, such as a keyboard, mouse, monitor, printer, etc., but a person skilled in the art will recognize how such elements can be added as needed. For example, in one embodiment, computer 105 includes multiple storage devices configured as Redundant Array of Independent Disks (RAID) devices. In another embodiment, computer 105 includes a Storage Area Network (SAN) for storing information. In a third embodiment, computer 105 includes an Uninterruptible Power Supply, so that computer 105 can shut down safely in case of a power failure. A person skilled in the art will also recognize that not all of these elements are needed at any particular time.

To generate codes and respond to inquiries, computer 105 includes several components. First is code generator 110. As its name implies, code generator 110 is responsible for generating codes. Code generator 110 includes random number generator 115, which is responsible for generating random numbers. Random numbers are used because any rational scheme to enumerate or label products invites someone to counterfeit the product using the same labeling scheme. But if the label is a purely random code and there is no other information on the object, then counterfeiting the product ranges from difficult to impossible depending on the client's selected level of record-keeping or the number of items counterfeited.

In one embodiment, code generator 110 generates codes in base-35. Using base-35 allows codes to be written easily using the alphabet (except for the letter “O”) and the digits 0-9. This enables codes with very large values to be written using relatively few characters. For example, the decimal number “4,596,374,268,234,817,290,392,719,638,653,834,614,271,341,024” can be represented in base-35 as DK3E NYXP SKLW ZJ5S. (The spaces in the base-35 code representation shown are for easily readability, and are not part of the code.) But a person skilled in the art will recognize that other bases can be used. In addition, codes can use graphical symbols other than the Roman alphabet. For example, the Kanji character set, used in Asian countries, includes thousands of characters, and offering roughly 10⁶⁴ different codes. Even non-alphabetic graphical symbols can be used, although using known alphabets allows for easy input as a human inquiry, with a keyboard, by handwriting, or orally.

In one embodiment, the generated codes have a number of characters that is a perfect square: for example, 16, 25, or 36 characters. Having codes of these lengths allows codes to be printed in square blocks, which makes for ease of use. But a person skilled in the art will recognize that the reason for such code lengths is purely cosmetic. Codes can be of any length, and can be printed in any configuration desired. In addition, codes of different lengths can be generated for different objects, depending on the desired application. Thus, a code assigned to a t-shirt might have 16 characters, whereas a code assigned to an individual medication pill might have 36 characters.

The codes that are generated are not only random, but also have no meaning in and of themselves, both before and after generation. There is no relationship between the object and the code. Thus, while one particular code might represent ajar of BB's Strawberry Jam, the next number might represent a radiator manufactured by SmithCorp (an automobile manufacturer). Or there might (and in all probability, would) be a very large gap until the next used number. And the next jar of strawberry jam off the BB's fill line might have a code that is trillions and trillions of codes away from the previous jar of jam. The only meaning is found in the association between the code and the object.

That the codes are randomly generated means that a third party cannot determine any useful information about products and production systems. In contrast, serial identification methods (e.g., labeling the first jar of strawberry jam SJ1, the second jar SJ2, and so forth) make it easy for third parties to glean information about production: the code is easily cracked. The random nature of the codes encourages a level of trust by companies in the registry.

The associations between codes and objects are stored in a registry, such as database 120. Database 120 can be any variety of database: e.g., relational, object-oriented, etc. Database 120 can also be distributed: that is, part of a SAN, if desired. Redundancy, to protect against the accidental loss of data, can also be implemented. For example, database 120 can be copied on a second storage of computer 105, so that if one storage device fails, the database is still available on the other storage device. Database 120 can perform all typical database operations: adding entries to the database, removing entries from the database, and searching the database for values.

In one embodiment, database 120 associates object identifiers, typically short descriptions of the objects, such as “t-shirt,” “ball bearing,” or “BB's Strawberry Jam,” with the codes. These descriptions are assigned by the manufacturers of the objects. In another embodiment, the stored value associated with the code in database 120 might be a URL or other identifying Internet address where the manufacturer maintains the data describing the object. In yet another embodiment, database 120 also stores additional information about the object. For example, database 120 can store detailed information about the object, such as where the jar was produced (Sheridan, Oreg.), how many jars were produced before the jar (66), from which farm the berries came (Johnson's farm), and when the berries were picked (June, 2002). In addition, a database entry can be linked to other database entries, indicating that there is some relationship between the linked objects. (A person skilled in the art will recognize that the term “link” here means only an association or cross-reference within the database, and would be interpreted broadly to encompass any way to cross-reference entries in database 120.)

Database 120 can also flag information with different publicity levels. Certain information can be made available to anyone, whereas other information should be released only to certain parties. For example, the maintenance records of an aircraft are important to the owner of the aircraft (and to the Federal Aviation Administration), but might not be important to a random person inquiring about the aircraft (unless the person happens to be a passenger on the aircraft). Thus, when the aircraft owner or the FAA makes an inquiry about the aircraft, they can see the maintenance history, but an ordinary person would not see anything more than the bare record of the aircraft.

One functionality that is typically not offered by database 120 to general inquirers (although manufacturers can use this feature, if offered) is text-based searching. That is, an inquirer can search database 120 for a particular code, but not for a particular text string. This is to prevent counterfeiters from being able to locate a code assigned to the objects they want to counterfeit. If a counterfeiter could search for “t-shirts,” they could locate a valid code for the t-shirts he wanted to counterfeit. But if the counterfeiter has to randomly guess codes, he would run out of patience long before he achieves any success. (Realize that the counterfeiter needs to copy a valid code for the counterfeited product: a missing code, a code that was never issued, or a code assigned to an entirely different product would all immediately raise a red flag.)

The reason the counterfeiter would give up is a consequence of the sparsity of codes. Selecting 16-character codes using base-35 arithmetic offers roughly 5×10²⁴ different codes. This means that there are 10¹⁵ codes for each man, woman, and child alive today. Going to 36-character codes, the number of possible codes increases to almost 4×10⁵⁵. And with an estimate of 10⁸² atoms in the entire universe, going to a 53-character code would provide enough codes to identify every atom in the universe. With at least 10¹⁵ codes per person available, it is hard to imagine how anything more than a tiny fraction of the possible codes will ever be used. Simply guessing about a particular made-up number would be unlikely to successfully match anything. Entering one code every 10 seconds would require many years of entries to match anything. And even then, it would only be something, not necessarily the object the inquirer was hoping for. Requiring a separate log-on/log-off session for each inquiry inserts an insurmountable time barrier to anyone seeking to profit from such (illicit) casual inquiry by using massive or automated inquiries to discover valid codes. Any inquiry needs a scheme in order to succeed and the only workable scheme here is possession of genuine codes, which are very hard to guess.

To receive requests for codes and to respond to them, computer 105 needs to be able to communicate. Receiver 125 and transmitter 130 are responsible for communication. Receiver 125 receives communications from parties interested in requesting codes (or parties making inquiries about codes), and transmitter 130 transmits responses.

Code comparator 135 is responsible for comparing two codes. Code comparator 135 is typically built into the search functionality of database 120. But if database 120 lacks a search capability, a search capability can be emulated using code comparator 135. Code comparator 135 takes two codes, compares them, and indicates whether the codes are the same.

Verifier 140 provides manufacturers with some assurance that computer 105 can prevent counterfeiters from passing off their products as the manufacturer's. Verifier 140 checks, when a request for a new code comes in, whether the requester is in fact the supposed manufacturer of the product. In one embodiment, verifier 140 uses the manufacturer name to determine a code in database 120 associated with the manufacturer, and uses code comparator 135 to compare that code with a manufacturer code received along with the request for a code for the object. If the codes match, then the manufacturer is verified; if the codes do not match, then someone may be attempting to counterfeit an object as being produced by the manufacturer. The system can then contact the manufacturer and alert them to the potential counterfeiting operation, or can simply deny the code.

Verifier 140 can operate in other ways as well. Instead of searching for the manufacturer's name, verifier 140 can search database 120 for the provided manufacturer's code, and compare the resulting information about the manufacturer with information provided in the request. Or, verifier can prompt an operator of system 105 to contact the manufacturer for a phone confirmation. A person skilled in the art will recognize other ways that verifier 140 can operate.

In one embodiment, the components of computer 105 (such as code generator 110, random number generator 115, code comparator 135, and verifier 140) can be implemented as software. In another embodiment, the components of computer 105 can be implemented in hardware. For example, code comparator 135 can be implemented as a circuit to compare two given codes. A person skilled in the art will recognize how to implement the components of computer 105 as hardware.

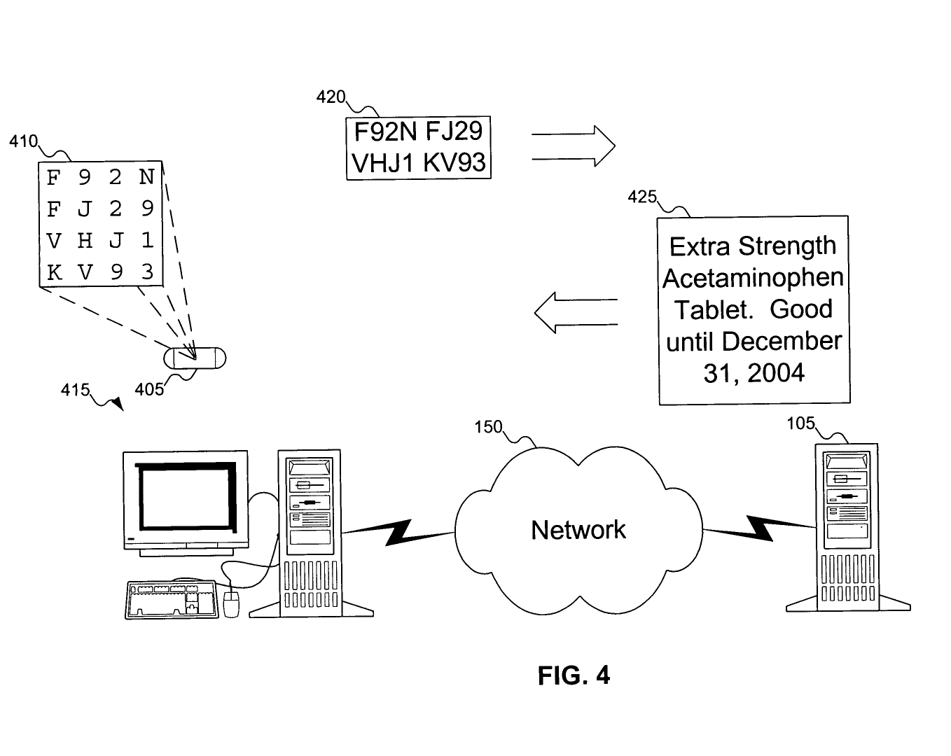

Finally, notice 145 is a standard notice that can be prepared in advance. Notice 145 is used to inform an inquirer that the provided code does not exist in database 120. As mentioned above and will be discussed below with reference to FIGS. 4-6, 8, 11A-11C, and 13A-13B, parties can make inquiries about codes. If the code is not found in database 120, notice 145 can be presented to the inquirer, informing him that the code is not recognized.

In FIG. 1, computer 105 is connected to network 150. Network 150 enables computer 105 to provide codes responsive to requests across network 150. Network 150 can be any variety of network desired. For example, network 150 can be a local area network (LAN), wide area network (WAN), metropolitan area network (MAN), or a wireless network, utilizing any wireless communications protocol, such as Bluetooth or any of the IEEE 802.11 a/b/g standards. (The Bluetooth standard may be found at “http:##www.bluetooth.com#dev#specifications.asp,” and the IEEE 802.11 a/b/g standards may be found online at “http:##standards.ieee.org#catalog#olis#lanman.html” (to avoid inadvertent hyperlinks, forward slashes (“/”) in the preceding uniform resource locator (URL) have been replaced with pound signs (“#”)).) Network 150 can also be a global network, such as the Internet, enabling users to request or inquire about codes from almost anywhere. Finally, network 150 can also be a telephonic network. That is, to reach computer 105, code requesters and inquirers dial a telephone number, and a modem connected to computer 105 (installed either internally or externally to computer 105) answers to establish the connection and interact with computer 105 either digitally or by voice.

In one embodiment, network 150 is the Internet. Database 120 can be accessed using a web browser by providing the appropriate interface. This provides essentially worldwide access to the service at any time.

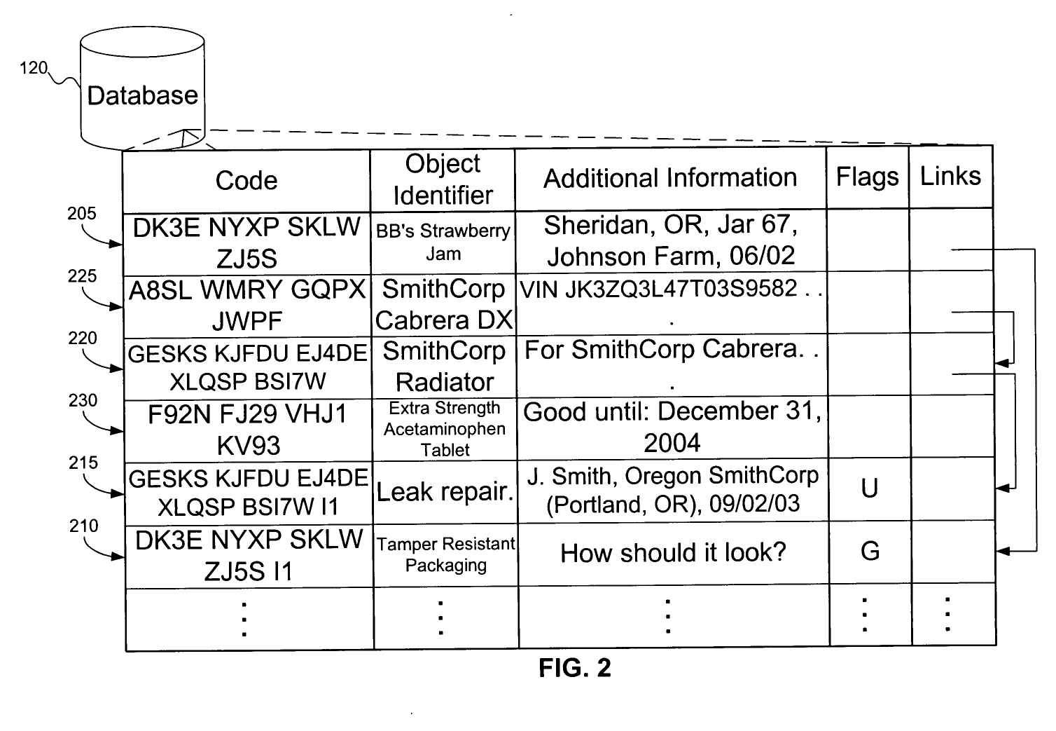

FIG. 2 shows details of the database of FIG. 1. In FIG. 2, database 120 is represented as a table, with links from entries to other related entries, but a person skilled in the art will recognize that other embodiments of the invention can be used.

In FIG. 2, entry 205 shows code DK3E NYXP SKLW ZJ5S, which is associated with ajar of BB's Strawberry Jam. According to the information included in entry 205, the jar was packaged in Sheridan, Oreg., was the 67^{th} jar of strawberry jam on the line produced that day, and includes berries picked in June 2002 from Johnson Farm.

Entry 205 also includes a link to entry 210. Entry 210 is an inquiry by a consumer, asking a question about the tamper resistant packaging. Perhaps the customer who purchased the jar of jam had a concern about the appearance of the tamper resistant packaging, and wanted to ask the manufacturer whether his jar was safe to eat. Notice that entry 210 uses the same code, supplemented with “I1” to identify the first inquiry about the jar. If a second inquiry were made about this jar of jam, the second inquiry would have the same code, but with “I2” appended to it. Using the same code for inquiries (with unique supplements) enables searching for an object and all inquiries about the object using a single code, although a person skilled in the art will recognize that inquiries could be located using the links even if assigned distinct codes.

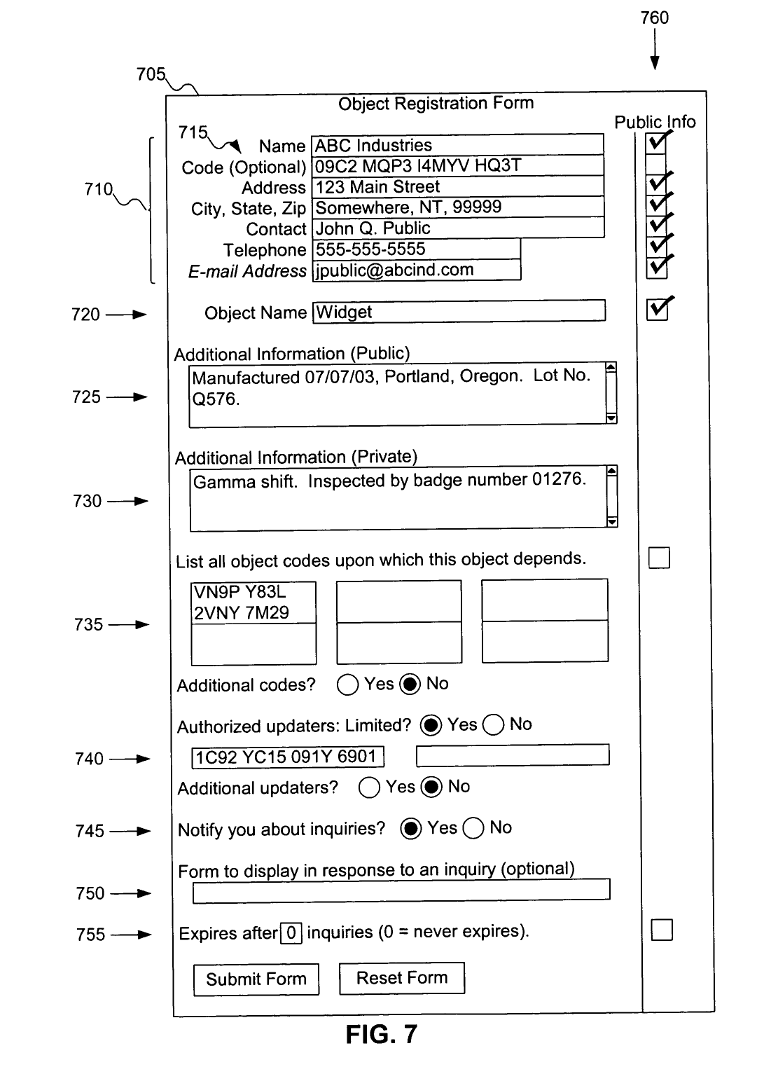

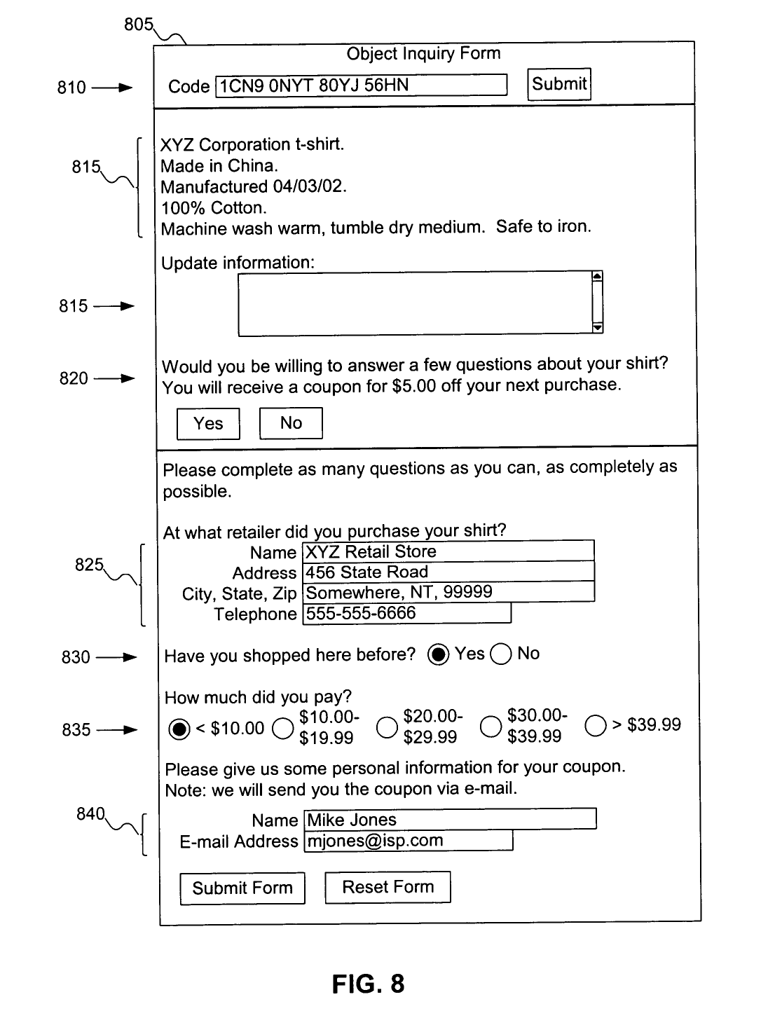

The flags column is used to flag certain entries. For example, entry 210 is flagged as a general inquiry, to indicate that is was made by a member of the general public. In contrast, inquiry entry 215 is flagged as an update inquiry, indicating that the inquiry was made by an authorized updater of the base entry (entry 220). Authorized updaters and general inquiries are discussed more below with reference to FIGS. 7 and 8.

Although entry 205 shows details about the berries used as part of the entry for the jar of jam, a person skilled in the art will recognize that information about the berries can be a separate entry, to which the jar is linked. For example, entry 225 identifies a particular automobile, manufactured by SmithCorp. This particular vehicle happens to include a particular radiator, which has its own code and is shown in entry 220. This enables someone making an inquiry about the vehicle to find out information about every coded part used in the vehicle. So, if a user makes an inquiry about code A8SL WMRY GQPX JWPF, they learn not only about the car itself, but also about the radiator installed in the car, and even potentially about the repair to the radiator (shown in entry 215). Of course, the code for an object like a vehicle that has numerous components could be linked to all components, not just one, so that an inquiry about the car would find out information about every part in the vehicle.

Entry 220 is shown as a 25-character code, whereas all of the other entries are shown as 16-character codes. In one embodiment, as discussed above, codes can be of different lengths. FIG. 2 shows that codes of different lengths can be used at the same time. In the remainder of this description, all codes presented are 16-character codes. But a person skilled in the art will recognize codes of different length can be used as desired.

As discussed above with reference to FIG. 1, the code requester can store additional information with the object identifier. Entry 205 shows this use for jam. Entry 230 shows this feature applied to medicine. Entry 230 identifies an individual capsule of acetaminophen. Included with the object identifier is the date upon which the medicine expires. When an inquiry is made of the capsule of acetaminophen, the expiration date can be displayed, and can also be compared with the system date. If the system date is past the medicine's expiration date, then the system can display a warning to the consumer not to ingest the medication.

Although FIG. 2 shows the additional information as distinct from the object identifier, a person skilled in the art will recognize that the two fields can be combined. In addition, a person skilled in the art will recognize how entries in database 120 can be further subdivided: for example, the additional information can be divided between public and private information (that is, information that anyone can view and information that is available to only certain users). Then, based on information provided by the user at the time of inquiry (e.g., a login ID and password), the amount of information presented to the user can be customized.

In another embodiment, the additional information is not stored directly in database 120. Instead, the additional information stores a link (usable, for example, with a browser across the Internet) to a site that stores the information to be presented to the inquirer. Using a link allows a single screen of data to be presented to any inquirer without repeated entry of the information into database 120. In another embodiment, the additional information can store a link to a file (as opposed to a link across the Internet) with the pertinent information.

Although FIG. 2 shows the entries in database 120 as linked, a person skilled in the art will recognize that links can be simulated, if database 120 does not implement cross-references. For example, entry 225 can include a list of the codes of all parts in the car: this list would include the code in entry 220. (Of course, for an object like a car or airplane with potentially thousands of components, this list would get very long.) Where cross-references are simulated, it is useful to give inquiries codes based on the code of the object about which the inquiry was made, to keep the list of cross-references as short as possible. A person skilled in the art will recognize other ways in which links can be handled. In addition, a person skilled in the art will recognize that cross-references can be skipped if desired. A manufacturer is not required to request codes for each component of an object (although doing so can be useful where tracking the history of individual components is important). For example, a manufacturer of toasters can choose to request codes for each component of the toaster, or just one code for the toaster as a whole. In this example, because there is little value added to tracking the components of the toaster, the manufacturer might choose to only request codes for the toaster itself, and not any of its components.

Another use of the codes not shown in FIG. 2 is to represent abstract concepts. Similar to how an aircraft is a collection of parts, codes can themselves be grouped, and the group assigned a single code. For example, a manufacturer might request a code to represent “all jars of j am produced at a particular canning factory on Jun. 24, 2002,” “all tape recorders produced by a particular manufacturer returned for repair under warranty,” or “all socks sold to 14-18 year olds,” among others. Requesting codes for such abstract concepts enables analysis that might be of value to some group (be it manufacturers, consumers, consumer interest groups, etc.).

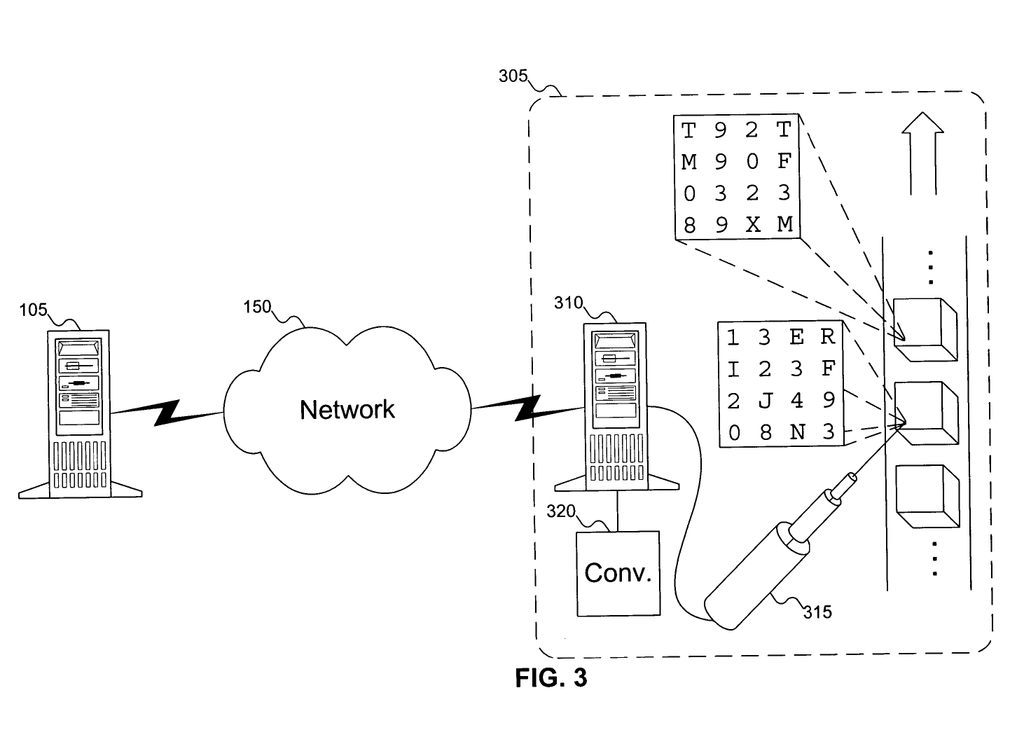

FIG. 3 shows a manufacturer etching codes generated by the computer of FIG. 1 on objects. In FIG. 3, computer 105 is connected to network 150, across which business 305 is operating. Business 305 includes computer 310, which is connected to laser 315. Computer 310 requests codes for objects as they roll along the production line. As each object passes under laser 315, computer 310 instructs laser 315 to inscribe a code received from computer 105. For example, the object currently under the laser has been etched with the code 13ER 123F 2J49 08N3, whereas the immediate predecessor object received the code T92T M90F 0323 89XM. Laser 315 can be of any laser type suitable to the material to be etched. For example, laser 315 can be an Yttrium-Aluminum-Gamet laser if the objects are metal.

A person skilled in the art will recognize that the codes can be printed using techniques other than laser etching. For example, with medication in pill form, the code can be stamped onto the individual pills. And inkjet printers can print codes on many surfaces.

The codes can be made as large or as small as desired. For example, a code can be printed using fairly large fonts for easy readability, as large as (or even larger than) one inch square. Or the codes can be printed small, so that they are not easily located (if camouflage is desired) or safely tucked away in a convenient spot.

The codes can be placed anywhere on the object desired. For example, for a capsule of medication, the codes can be stamped or printed on the capsule anywhere. For machine parts that are subject to high wear (e.g., oil field “downhole” tools, such as tubing and connectors), information placed on these tools is quickly worn off the outside surface by friction, and information placed on inside surfaces is corroded off by chemicals being transported by the tubes. The codes can be made to be so small that they can be placed in protected areas such as on the flange lips where the threaded connections bring the tubes together and connect them to one another. There are small grooves there that a code can safely reside on and since a single code can be repeatedly applied to a single part, at least one of them can be reliably counted on to survive the wear and tear of use. For bullets, the code can be placed on the flat base of the bullet, inside the protective casing. The act of firing does not harm the code etching and the base of the bullet is the part least deformed by subsequent impact with the target. A crime scene investigator can quickly establish who sold the bullet, and often who bought the bullet (in addition to the standard process of determining which gun fired the bullet).

For some objects, it is not practical or viable to place the code directly on the object. For example, synthetic Insulin is a liquid medication. It is not practical to mark the Insulin itself. But the pharmaceutical company can laser etch its glass containers with the codes. Or an insert can be placed in the package with the container (or glued to the vial), the insert imprinted with the code. A person skilled in the art will recognize other ways in which the code can be coupled to the object.

Another situation in which it is inconvenient to place the code on the object being marked is for agricultural products, such as corn, wheat, rice, etc. The problem is not that the codes cannot be placed on the objects: codes can be easily be made small enough to be placed on objects smaller than an individual grain of rice. But marking each kernel of corn is not practical. Instead, occasional kernels of coded white corn or lima beans can be inserted into a shipment of yellow corn: for example, two or three per cubic meter. (Less visible kernels of rice can be labeled and used in the same way if more covert approaches are desired.) These coded, separable grains provide the necessary tracking information, without affecting downstream processing of the corn. As the corn moves along a conveyor belt, a large green lima bean will be easy to spot and retrieve, and the code can then be found and used to verify the source of the corn. (If it is desired that the markers not be visible to end consumers, the relative size of lima beans as compared with kernels of corn would enable easy sorting. And if white corn were used as a marker for a shipment of yellow corn, the product would not be compromised by the markers, because of the similarity of the marker to the product.)

Sometimes the location for the code is chosen for other reasons. For example, an object might be designed to be used only once, after which it should be discarded. The code can be placed somewhere on the object so that the code is destroyed when the object is used. The fact that the code is no longer present on the object lets others know that the object has been used. For example, some aircraft bolts, as a class, are allowed to be tightened only once. The code for an aircraft bolt can be etched on high friction area where it is destroyed by the setting of the proper torque levels. This might involve etching the code to a relatively shallow depth, as opposed to a deep etching done in a protected area of another object to produce a code that is visible after the object has been used.

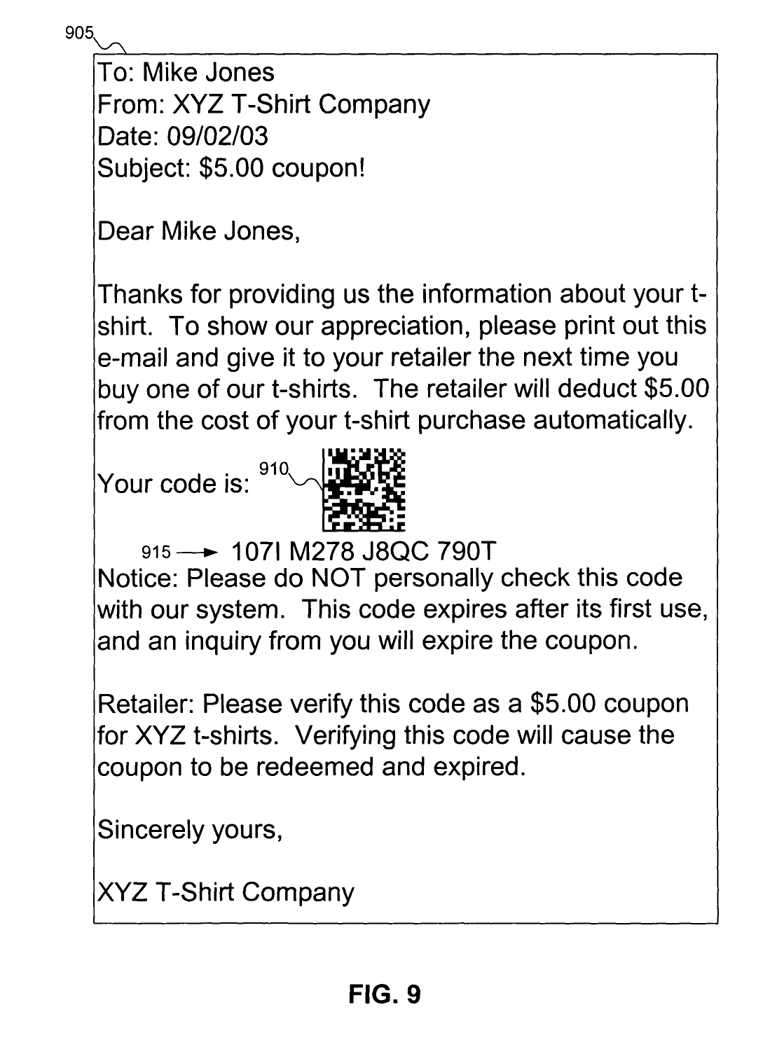

FIG. 3 also shows converter 320. Converter 320 converts codes from alphanumeric to machine-readable form. This enables laser 315 to etch a code that can be read by a machine (e.g., a scanner), rather than a code that a user would type or read to make an inquiry. An example of a machine-readable code is discussed below with reference to FIG. 9.

FIG. 4 shows a customer making an inquiry about a code from the computer of FIG. 1. In FIG. 4, the object about which the customer is making the inquiry is capsule 405 of medication, with code 410. The customer enters the code as an inquiry to computer 105 using computer 415. Computer 415 can be any variety of device capable of interfacing with computer 105. For example, computer 415 can be a personal computer (desktop computer, laptop computer, or notebook computer, among others), a personal digital assistant (PDA), or other electronic device. Computer 415 can even be a telephone, and not a computer at all. Using voice recognition software, computer 105 can recognize the code as spoken by the consumer, and respond with recorded information about the object (or use a voice synthesizer to “speak” the information about the object to the customer).

For example, communication 420 is the customer's inquiry about capsule 405. Message 425 is the response, informing the user that the capsule contains acetaminophen, and the medication expires Dec. 31, 2004.

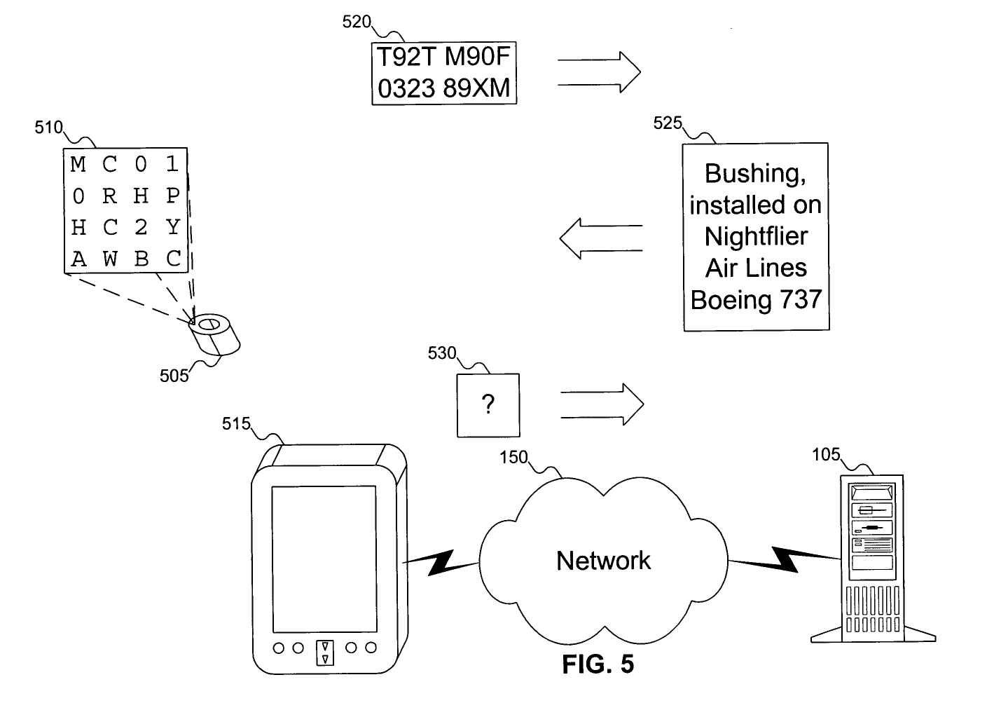

FIG. 5 shows another customer making an inquiry about another code from the computer of FIG. 1. Similar to FIG. 4, the customer is inquiring about object 505, with code 510. In FIG. 5, object 505 is a bushing for airplanes. The customer is using PDA 515, and operating wirelessly. The customer sends inquiry 520, and receives back information 525, indicating that the bushing is currently installed on an airplane owned by Nightflier Air Lines. The customer then sends communication 530. But what is in communication 530?

What the customer sends in communication 530 depends on the situation. For example, the customer might be a mechanic for Nightflier Air Lines, performing routine maintenance on the airplane. The mechanic has just inspected bushing 505, and ready to document his inspection. In this case, the customer sends an update in communication 530, indicating his inspection and whatever notes are appropriate.

But what if the customer were buying spare parts for another airplane? Either bushing 505 is authentic or it is not. If bushing 505, offered to the customer, is authentic, then the bushing on the Nightflier aircraft is suspect. And if bushing 505 is counterfeit, then someone somewhere handled the authentic bushing, and used the code on counterfeit bushing 505. (the party that intercepted the legitimate code might not be the party that produced the counterfeit bushing, as he might only have forwarded the legitimate code to another party.) Either way, customer 505 is instantly aware that there is a problem with bushing 505. The customer can then send a warning in communication 530 to computer 105, so that Nightflier Air Lines can be notified about the problem, and to flag bushing 505 as having been counterfeited or replaced.

(Similar to the corn shipment described above with reference to FIG. 3, the actual source of the problem might not be immediately apparent, but someone who worked on the Nightflier aircraft is likely involved, which significantly shortens the list of possible suspects. How the list of suspects can be further narrowed is discussed below.)

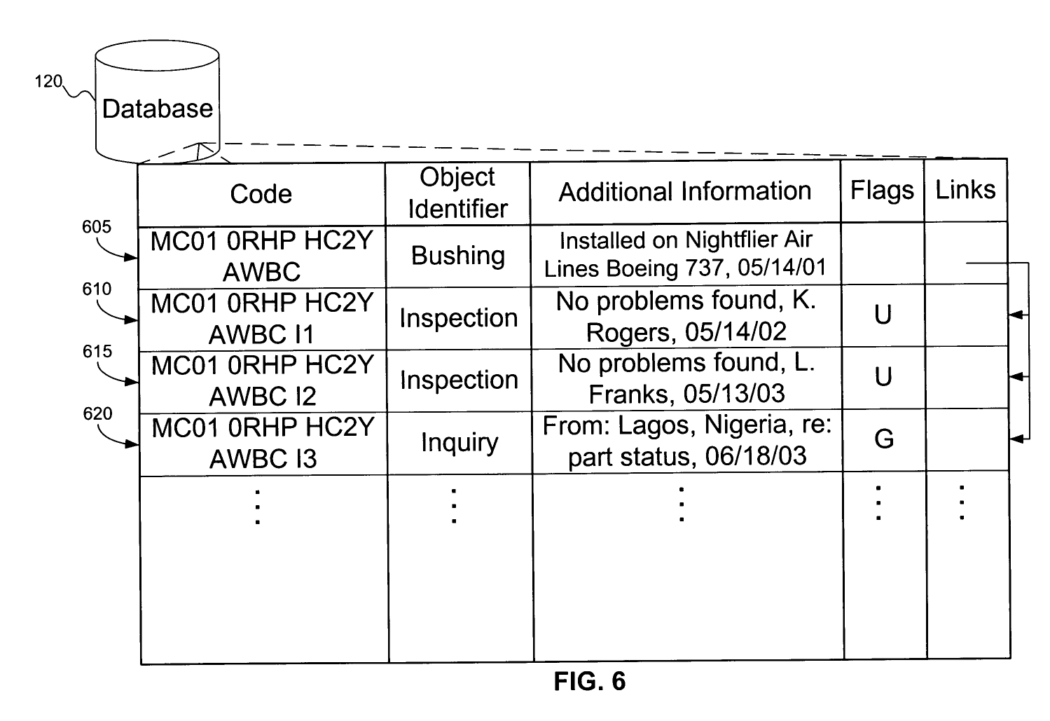

FIG. 6 shows how the database of FIG. 1 might look in the situation described above in FIG. 5, where a customer is considering buying the bushing. In FIG. 6, database 120 shows four entries. Entry 605 is the primary entry for the bushing, showing that the part was installed on the Nightflier aircraft. Entries 610 and 615 show various inspections of the bushing, attesting that the bushing was found to be fine. Entry 620 is the inquiry by the customer considering buying the bushing. (Note that entries 610 and 615 are flagged as update inquiries, whereas entry 620 is flagged as a general inquiry.)

FIG. 7 shows a form used by a client of the computer of FIG. 1 to generate a new code. In FIG. 7, form 705 has fields for all the options a requester might have in requesting a code for an object. General information fields 710 requests the general information about the requester: name, address, telephone, etc. Of particular interest is code field 715. As mentioned above with reference to FIG. 1, a business can have a code of its own, even though the business might not be generally considered an “object.” The business can keep its code confidential, so that only parties authorized to request codes on behalf of the business know the code. By providing a code for the business, the business helps to verify its authenticity as an object producer. The code provided can be compared against a known code for the business: if they match, then the business is probably legitimately requesting a new code.

Name field 720 is where the requester provides the name of the object. This name becomes the object identifier stored in the database, as discussed above with reference to FIG. 2.

Additional information fields 725 and 730 are spaces where the requester can provide additional information about the object. Field 725 stores public information, displayed to anyone inquiring about the code to be assigned to the object; field 730 stores private information, useful to some parties but not significant to general inquirers.

Related code fields 735 provide places where related codes can be listed, so that the entry in the database for this object can be linked to related objects. The requester can link the object to as many other objects as desired: in FIG. 7 only one related object is listed. Related code fields 735 can be entered in any manner desired: they can be typed (using a keyboard), dictated (to voice recognition software), or scanned (from the code on the related objects, if available), among other ways.

Updater fields 740 provide a way to allow other parties to make updates to the entry in the database. More specifically, updaters 740 identifies parties that are entitled to do more than make general inquiries about the object. For example, if the object is a bushing for an airplane, the bushing will need to be inspected, and an inspection report made. The inspection report is more than just a general inquiry: it adds official information about the bushing into the record. If anyone who happened to know or stumble upon the code for the bushing could update the record for the bushing, theoretically a nefarious party could enter a report that the bushing failed an inspection, thereby grounding the aircraft. Fixing the record would be time consuming and costly, and under adverse circumstances could even drive a company out of business. By limiting who can make such updates, mischief can be prevented.

Limiting who can update an entry is useful for objects that can be critical to a business. As mentioned above, a report that a bushing failed an inspection could ground an aircraft. For a freight company that owns only one large aircraft, being grounded could end the business. But a report of a problem with a t-shirt, even if false, is not likely to drive a business to bankruptcy. For “non-mission-critical” objects, limiting updates can be skipped.

Note that updaters 740 uses codes to identify authorized updaters. These codes can identify businesses or groups of individuals that are authorized to make updates. But these codes can also identify individuals who are authorized to update fields. Just like businesses, individuals can have their own codes. If the individuals protect their own personal codes, they can be used to identify the individuals as needed.

Notify field 745 allows requesters to specify if they want to be notified about any inquiries on the object code. If a manufacturer expects that any inquiry is significant, the system can automatically notify the manufacturer about the inquiry. But if the number of inquiries is expected to be large, or the inquiries are not likely to be important, the manufacturer can opt to not be notified about inquiries.

Not shown in FIG. 7 is an option to notify parties other than the manufacturer. For example, if an inquiry comes in about an airplane bushing, although the manufacturer of the bushing might be interested, the party most likely affected is the owner of the aircraft. Such an option can be added, by having someone authorized to update the record for the object change the party to which the object is registered. At that point, the company that receives the registration is treated as the manufacturer. But in another embodiment, notices are sent not only to the party that registered the object, but also to all other parties that have registered objects linked to the object about which the inquiry was made. And in yet another embodiment, the two alternatives are combined. For example, one company might manufacture the bushing, a second might assemble the aircraft, and a third might own the aircraft.

Form field 750 is a place where the manufacturer can specify a form to be used when an inquiry is made about the object. A person skilled in the art will recognize that different forms can be used with different objects. For example, the form used when inquiring about an aircraft bushing very likely will ask different questions than the form used by a t-shirt manufacturer responding to a customer inquiry. In one embodiment, the form linked via form field 750 can be stored remotely from computer 105. In that case, the computer storing the form provides information from the completed form to the database to complete the inquiry entry. In another embodiment, the form is stored on computer 105, so that information entered into the form can be directly placed in the inquiry entry. In that case, the computer 105 forwards the information to the manufacturer.

Finally, expiration field 755 provides a way for manufacturers to expire the code after a certain number of inquiries. As discussed above with reference to FIG. 3, codes can be placed on the object in such a manner as to “erase” the code as the object is used. Expiration field 755 provides a way to expire codes through inquiries. This can be useful where the code is not likely to be destroyed when the object is used. For example, a coupon can printed with a code. When the customer takes the coupon to the store, the retailer's inquiry about the code expires the coupon. This prevents retailers from keeping a single coupon at the register and using the coupon repeatedly as customers approach. Each customer, to receive the discount of the coupon, would need a different coupon with a unique code. This allows manufacturers to select highly specific individuals for coupon distribution.

Although not shown in FIG. 7, a person skilled in the art will recognize that other events can be used to trigger the expiration of the code. For example, the code can be set to expire at a particular day and time. Or the code can be set to expire after a signal from the manufacturer. In addition, combinations of these events can be used to trigger the expiration of the code. For example, coupons typically have a limited “shelf life,” whether or not they are used.

Public information check boxes 760 provide a way for the requester to indicate what information should be made available to public inquiries. As can be seen in FIG. 7, this requester has indicated that all general information fields 710 should be public, except for the manufacturer's code, and that name field 720 should be public. This means that, if anyone inquires about the code to be associated with this object, he will be told the company name, address, contact person, telephone, and e-mail address, and the name of the object, along with all information in public additional information field 725 (which, by definition, is public). Only inquiries from authorized persons can find out the manufacturer's code (code field 715), the private additional information (private additional information field 730), related objects (related code fields 735), authorized updaters (updater fields 740), and expiration conditions (expiration field 755).

Once the requester has completed form 705, they press the submit button. This submits the form to the database. Assuming everything is correct (e.g., the manufacturer is verified), then computer 105 returns a code to the requester, which can then be placed on the object.

As discussed above with reference to FIG. 3, code requests can be computer-generated. Although a program could be designed to manually complete form 705, it is simpler for the manufacturer to have a computer automatically generate the messages sent to computer 105, with all the fields stored properly. This speeds up the process considerably, and limits the possibility of human error in requesting codes.

In another embodiment, rather than having the manufacturer request codes for individual objects, the manufacturer can request a “block” (that is, a set of some predetermined size) of codes. The manufacturer can then assign these codes individually to objects, and later update the database of the service to reflect which code identifies which object. In yet another embodiment, the manufacturer can provide the identifiers for the objects in making the request for the block of codes, and can then place the codes on the objects as they are associated in the database of the service.

In yet another embodiment, the manufacturer can request a block of codes with some conditions. For example, a company might use an existing internal numbering convention for its products. Rather than simply abandoning its existing system, the company might request that all codes in the block have a unique prefix of, say, ten characters. These 10 characters can then be used to internally identify the products, with the complete code being used within the service. The service can then randomly generate enough codes to fill the block, filtering out codes that repeat an earlier prefix. Notice that the codes are still entirely random, although drawn from a slightly smaller set.

FIG. 8 shows a form used by a customer to inquire from the computer of FIG. 1 about a code. In FIG. 8, only the top-most section of form 805 is presented to the inquirer, prompting him for the code. Once the user enters the code in code field 810 and presses the submit button, the middle section of form 805 is presented. This section presents the inquirer with the public information about the object (and the private information as well, if the inquirer is authorized to view the private information). For example, the code entered in code field 810 is shown as being a t-shirt manufactured by XYZ Corporation, was manufactured in China from 100% cotton on Apr. 3, 2002, and provides cleaning information.

Update field 815 provides the inquirer with the opportunity to submit a question to the manufacturer. Although members of the general public cannot officially update the record of an object, they can add their thoughts, ideas, questions, and so on. Authorized updaters can use update field 815 to add official entries to the record of the object. Whether or not an inquirer is authorized determines how the inquiry is flagged in the database.

Because the manufacturer of the t-shirt whose information is shown in FIG. 8 added a form for customers, offer 820 is presented to the inquirer. (As part of adding the form, the manufacturer can make the offer of the coupon shown, or any other offer desired.) If the inquirer opts to complete the form, then the bottom-most portion of form 805 is shown. The form asks the inquirer for information about where the t-shirt was purchased (fields 825), whether the inquirer had shopped there before (field 830), how much the inquirer spent on the shirt (field 835), and some personal information (fields 840). The personal information is then used to send the inquirer the promised coupon (see FIG. 9).

The reasons why manufacturers might prepare forms like the bottom portion of form 805 are endless. Typical examples of reasons to prepare the bottom portion of form 805 include customer demographic information and customer preferences. But there are other reasons as well. For example, the manufacturer can use the information received to stop counterfeiting or diversion of goods.

Consider a t-shirt manufacturer that places a code on each t-shirt manufactured. Along the way, a counterfeiter obtains one t-shirt and copies it, right down to the code. (If the t-shirt were lacking a code, the customer would be instantly aware that the t-shirt is counterfeit.) The counterfeiter then sells batches of the counterfeit t-shirts to venders. A customer buys one of the counterfeit shirts, and registers his purchase by making an inquiry of the code on the shirt. The manufacturer knows where the original shirt was supposed to go (for example, New York, N.Y.), but the inquirer indicates that the shirt was purchased somewhere else (e.g., Los Angeles, Calif.). Since the code is authentic, the manufacturer knows that someone in the distribution chain for the authentic shirt is involved in the counterfeiting operation. By tracing the supply chain backwards from the customer, the manufacturer can eventually identify the party working with the counterfeiters.

It is true that typically only a small percentage of customers will make inquiries based on the code on their shirts, and that one inquiry might not be enough to identify the party working with the counterfeiters. In fact, a single inquiry might not be enough to alert the manufacturer to the fact that a counterfeiter exists. But if a few inquiries arrive from different locations about the same code, this is strong evidence that someone has copied the code onto other goods, suggesting that the t-shirt has been counterfeited. And if even 10,000 counterfeit shirts were produced (a relatively small profit margin for the counterfeiter, bearing in mind the low profit margin of t-shirts in general), five inquiries is 0.05% of the counterfeit supply. Inquiries about a even a small percentage of the counterfeit t-shirts can spoil the game by marking audit trails.

To identify the counterfeiters, the manufacturer looks for common elements in the distribution chains of the counterfeited goods. Logistics system diagrams are frequently described as “trees” because their pattern of flow looks like a tree with the customers at the leaves and the shippers traveling down along the branches combining their loads at the places where the branches split apart. If two logistics trees for shipment are found to be contaminated, the junctures the two have in common when juxtaposed will identify the contamination site(s).

FIG. 9 shows a code generated by the computer of FIG. 1 used in a coupon. FIG. 9 shows e-mail 905 generated in response to the inquirer completing the form shown in FIG. 8. Note that e-mail 905 includes machine-readable code 910, along with corresponding alphanumeric code 915. The inquirer can then take a printout of e-mail 905 to a retailer the next time he purchases an XYZ Corporation t-shirt, and receive the $5.00 discount. The retailer simply scans in machine-readable code 910 (or types or otherwise enters alphanumeric code 915), and XYZ Corporation transfers $5.00 to the retailer's account.

At this point, some uses of the codes have been explained. A person skilled in the art will recognize other possible uses. For example:

Identifying a unique object in combination with other technology. For example, Radio Frequency IDentification (RFID) tags are under consideration as a way to allow customers to make purchases more quickly. After receiving a signal from a short-range transmitter, the RFID tag responds with information about the object. RFID is essentially a new version of the now-ubiquitous Universal Product Code (UPC) barcode, which stores use to quickly determine the price for products. Just as the same UPC is used for each copy of an object, the same RFID is used on all copies of an object, which means that RFIDs do not uniquely identify objects. But the RFID tag could transmit a code instead of the electronic equivalent of the UPC barcode, which could then be used with the service to uniquely identify an object. The code could also relay information such as the object's price, enabling quick sale of the object using RFID technology.

Another example use of codes could be to identify an object's location. For example, an object can use the Global Positioning System (GPS) to locate itself. If the object is not where it ought to be, it can send a message (e.g., wirelessly), identifying itself with its code and its current location. This can be used, for example, in laptop computers. If a user accidentally leaves his laptop computer in the trunk of an automobile, the laptop can determine its location. If the laptop is not in a normal location, after a while the laptop computer can send an e-mail to the owner, identifying itself and its location. This would help the owner retrieve the laptop.

Dealing with theft, diversion, and counterfeiting. A manufacturer can use the codes to identify where a code was originally sent (which manufacturing unit), which shift used that code, where the product was sent for distribution, and so on. Being able to follow delivery paths backwards from the customer's end makes any point of departure easy to spot and investigate.

A code allows anyone to quickly ascertain whether an object (part) is authentic. (The absence of a code is a sure warning.) If the “seller” tells a potential buyer that the object they are considering is “certified” and “new,” the buyer can quickly use the service from any convenient access point on the planet to identify the object. If the authenticity of the object is brought into question (the record indicates that the object is physically elsewhere at the time), the buyer can avoid the transaction, and the seller becomes suspect. In fact, the “authentic” object (the object actually located by the service) also becomes suspect, and its path to placement can be examined for common junctures with the paths of other previously revealed suspect parts to reveal the counterfeiter.

Customers can be encouraged to register or check their codes by being offered incentives for locating a counterfeit code. For example, if a customer is the first person to inquire about a code that turns out to be counterfeit, the customer can receive some benefit from the manufacturer. This helps involves customers in policing counterfeit goods. For example, if a customer makes an inquiry about an invalid code for a counterfeit t-shirt, the t-shirt producer might reward the customer with a coupon for a discount on their next purchase.

As discussed above with reference to FIG. 3, shipments of agricultural products can be tracked using coded lima beans (or other agricultural products that can easily be located and removed from the shipment). If a lima bean coded for a shipment of corn from a particular farm is found in a given shipment of corn, it supports the assertion that the corn, in fact, comes from that farm. If someone were to add grain, illicitly, over three or four shipments the particular point of contamination can be identified as the point that those shipments had in common. So if an elevator operator in Des Moines, Iowa is adding other corn to the coded lot, he will be isolated by his being the only component a particular contaminated shipment has in common with other contaminated shipments.

Protecting the identity of the source of the object. Traditionally, objects are marked with ample information identifying who manufactured the object, when the object was manufactured, lot information, and so on. This information acts a form of publicity about the manufacturer of the object. But there are circumstances when a manufacturer would prefer to hide its involvement with the object. For example, some parts of the world view America and American products with attitudes ranging from disdain to complete hatred. Advertising that an American company manufactured the object could lead to ridicule or to trouble for local distributors of American products. By having products labeled only with codes (rather than the traditional name and address of the manufacturer), the manufacturer's identity is effectively hidden.

Another reason that a company might want to hide its manufacturing of an object is to prevent threats against the company. For example, not too long ago news agencies around the world broadcast a video tape of Osama bin Laden. The middle thirty minutes were from a handheld video camera touring a helicopter crash site. During the tour, five different manufacturers of the aircraft's parts were identified as to their name and location, i.e., exact addresses. This identification could easily have been used by perpetrators bent on mischief. Someone interested in trying to hurt American military organizations might have used this information to attack these military suppliers, disrupting parts supply and potentially weakening American military might. But if the aircraft parts had been marked only with codes, troublemakers would not know the address or name of the company that manufactured the parts, and would not be able to cause problems.

Controlling the flow of information to a party known to be interested in mischief. Consider the situation where an object is known to be in the hands of a party interested in mischief (e.g., a counterfeiter). Inquiries related to the code on that object probably come from the mischief-maker. The inquiries can be backtracked to determine the location of the mischief-maker, and he can be fed misinformation to intentionally lead him astray. This approach could have been used, for example, in the earlier-described Bin Laden tape, if someone had made an inquiry about the code for a part known to have crashed in enemy territory.

Providing a modelfor official record keeping. As discussed above with reference to FIGS. 2 and 5-6, the codes can be used to create an official record with respect to an object. For example, as aircraft parts are maintained, the maintenance records can be stored as inquiries to the service about the object. If an accident should happen and a flight-critical part is discovered without a code, the party that recorded the last inspection of the part is a likely suspect for causing the accident. Identifying the correct culprit can place the liability for the accident on the correct shoulders: the mechanic, as opposed to the airline or the insurance company.

To further aid in record keeping, it is helpful if every party that makes contact with the object (other than the end user) updates the object record, even if such updates are not entered by authorized updaters. For example, when an object is placed on a truck for shipment, the trucker can make an entry that the object was received. When the object is inspected at a boarder, a customs agent can update the object to reflect that the object was inspected at a particular border crossing. (In fact, customs agents, along with other governmental officials, might be considered authorized updaters by default, as long as they are operating within their official capacities.) And so on.

In addition, individuals can use codes themselves: for example, to track objects downstream from their location, even if the objects do not have a code, or even to label personal products, such as home-canned jars of j am.

Providing limits to uses of objects that might otherwise be repeated. As discussed above with reference to FIG. 9, coupons are often copied or reused. This reuse costs the manufacturer money. By causing codes to expire, a limit on the number of uses of the code can be enforced, even if customers attempt to copy the codes improperly.

Ensuring the flow of information from manufacturers to end-users, and allowing information to flow from customers back to vendors, distributors, and manufacturers. When an object enters the customer's domain, it does not lose its connection to the manufacturer's knowledge base. A code maintains a link between the object, everything the manufacturer knows about the object, and the interests of the customer. This link is potentially perpetual, waiting to be useful to any of the parties involved. Code inquiries/customer registration can be encouraged by offering customers who register their products some benefit. For example, customers who register themselves to the code associated with their newly acquired object can be entered into a drawing for a coupon from their local retailer.

Often, there are more than two parties involved. There are also insurance companies, PR agencies, shipping companies, and suppliers, each of whom may want to collect just the tiniest bit of customer information to make themselves better companies. In past times this would be far too expensive a proposal, but now that the customers themselves can be self-organizing around a coherently indexed interchange (the codes of an embodiment of the invention), collecting information is nearly friction-free. Information is easy to acquire at any time, and in fact in near real time.

As discussed above, manufacturers have different incentives to use the codes. Some manufacturers want customer intimacy, others want quality control. The codes can also be used for inventory management. In all cases, the codes provide the same identity service: the same paradigm of trusted, neutral high quality coherency. Manufacturers can provide their associates, customers, or the general public with verbose and specific product information, such as safety alerts, merchant locations, expiration notices, Internet links, product service policies, customer registration portals or current ownership. Customers have an incentive to use the codes to receive the rewards offered by the manufacturers, and to receive timely and complete information about the objects from the manufacturers.

As discussed above with reference to FIG. 3, the codes can be placed on or with the objects. Rather than providing any additional information with the objects themselves, the customer can be directed to use the code to find out information about the object. For example, rather than placing inserts with small print into a package with medication, the customer can be instructed not to use the medicine until he has entered the code (or one code, for example if individual pills are marked) of the medication into the service. No other information is provided, not even the name of the pharmaceutical company or the name of the medicine. (By not disclosing even the type of medication, thieves would have to waste time determining exactly what medicine they have stolen. The medicine might then be held beyond its shelf life, making the theft a worthless endeavor.) When the customer enters the code into the service, the customer can receive all the necessary information: for example, the name of the pharmaceutical company, the proper dosage and duration of use, and the expiration date of the medication, all on a proper label printed at their home.

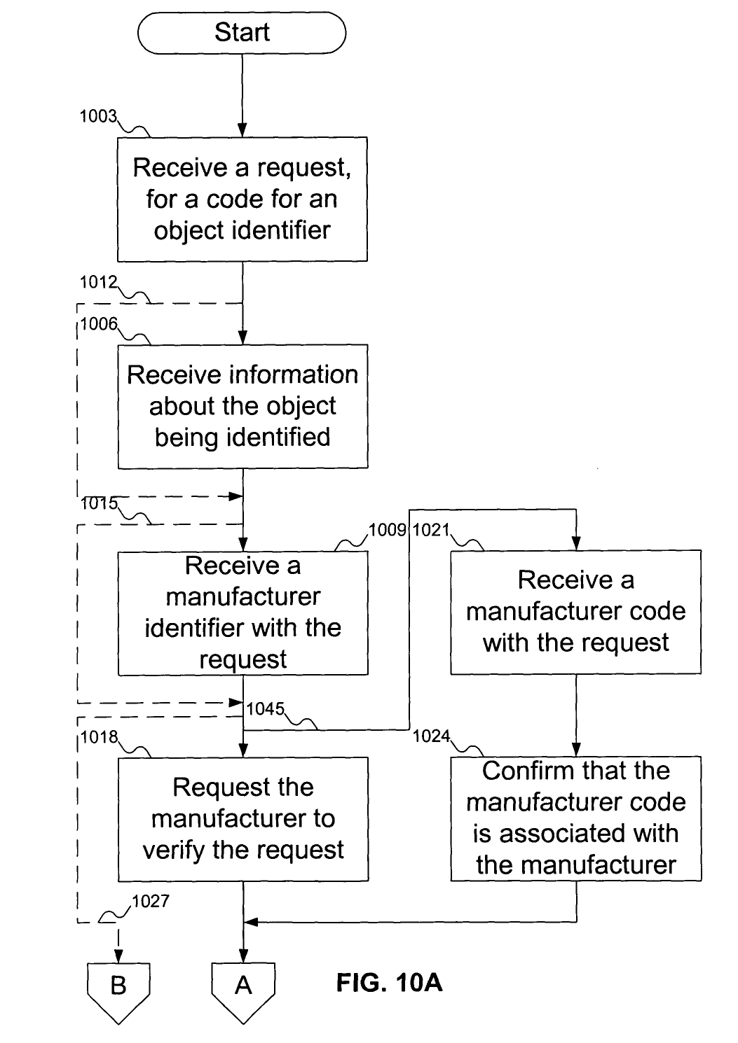

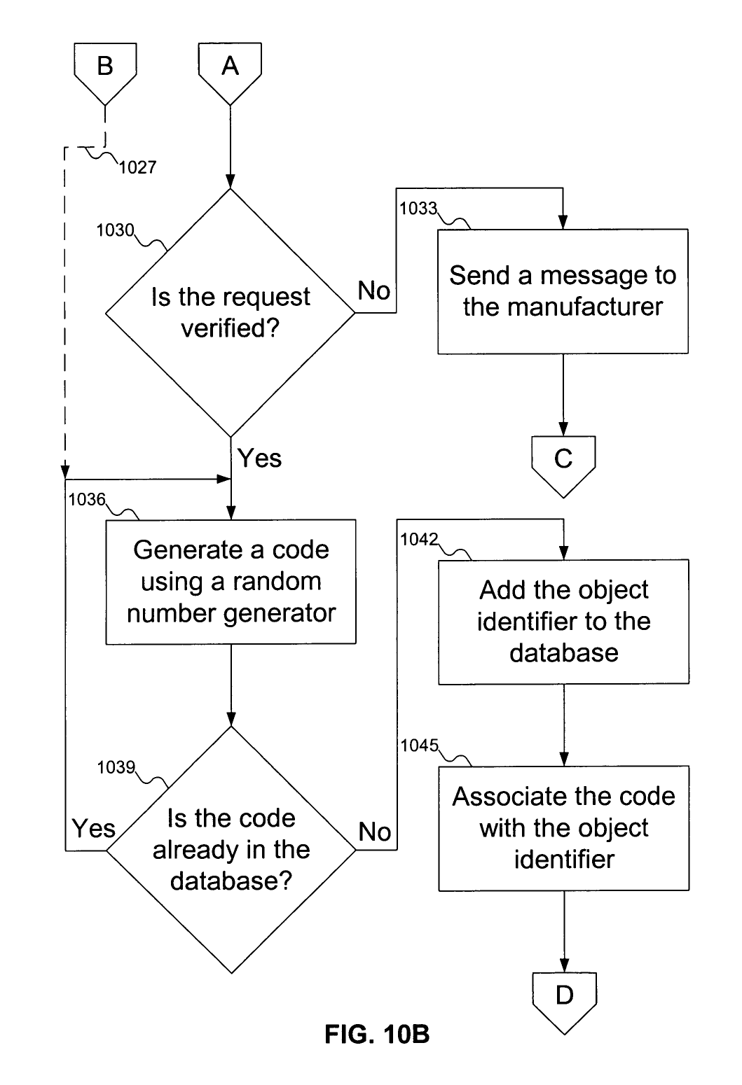

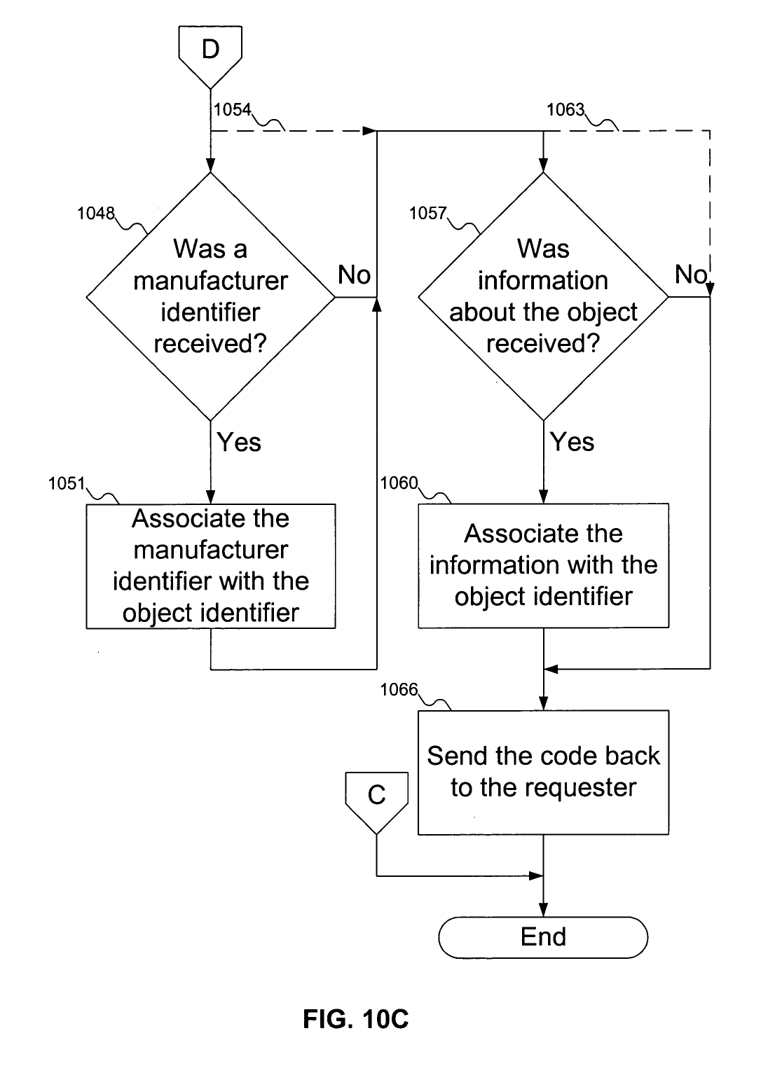

FIGS. 10A-10C show a flowchart of the procedure used by the computer of FIG. 1 to generate a code for an object. In FIG. 10A, at step 1003, the service receives a request for a code for an object. At step 1006, the service receives information about the object being identified. At step 1009, the service receives an identifier of the manufacturer of the object. As shown by dashed arrows 1012 and 1015, steps 1006 and 1009 are optional, and can be omitted independently.

After steps 1003-1009 are performed, the service can verify the manufacturer. This can be done in different ways. For example, at step 1018, the service can request that the manufacturer verify the request, perhaps by having an operator of the service speak with a representative of the manufacturer over the telephone, perhaps using another means of communication (such as e-mail). Alternatively, at step 1021, the manufacturer can provide a manufacturer code (known only to the manufacturer), which the service can use to verify the manufacturer's authority at step 1024. Step 1018, and alternatively steps 1021-1024, can be skipped, as shown by dashed arrow 1027 (which also skips step 1030 on FIG. 10B).

At step 1030 (FIG. 10B), the service checks whether the request was verified. If the request was not verified, then at step 1033 the service sends a message to the manufacturer about the verification problem. Otherwise, at step 1036 the service generates a code using the random number generator.

At step 1039, the service checks whether the randomly generated code has already been used (an unlikely prospect, given the sparsity of codes, but still a possibility). If the code was a duplicate, then control returns to step 1036 to generate a new code. Otherwise, at step 1042 the object identifier is added to the database, and at step 1045 the generated code is associated with the object.

At step 1048 (FIG. 10C), the service checks whether a manufacturer identifier was received (at step 1009). If a manufacturer identifier was received, then at step 1051 the manufacturer identifier is associated with the object identifier. As shown by dashed arrow 1054, steps 1048-1051 can be skipped.

At step 1057, the service checks whether information about the object was received (at step 1006). If information about the object was received, then at step 1060 the information is associated with the object identifier. As shown by dashed arrow 1063, steps 1057-1060 can be skipped.

Finally, at step 1066, the service sends the generated code back to the requester.

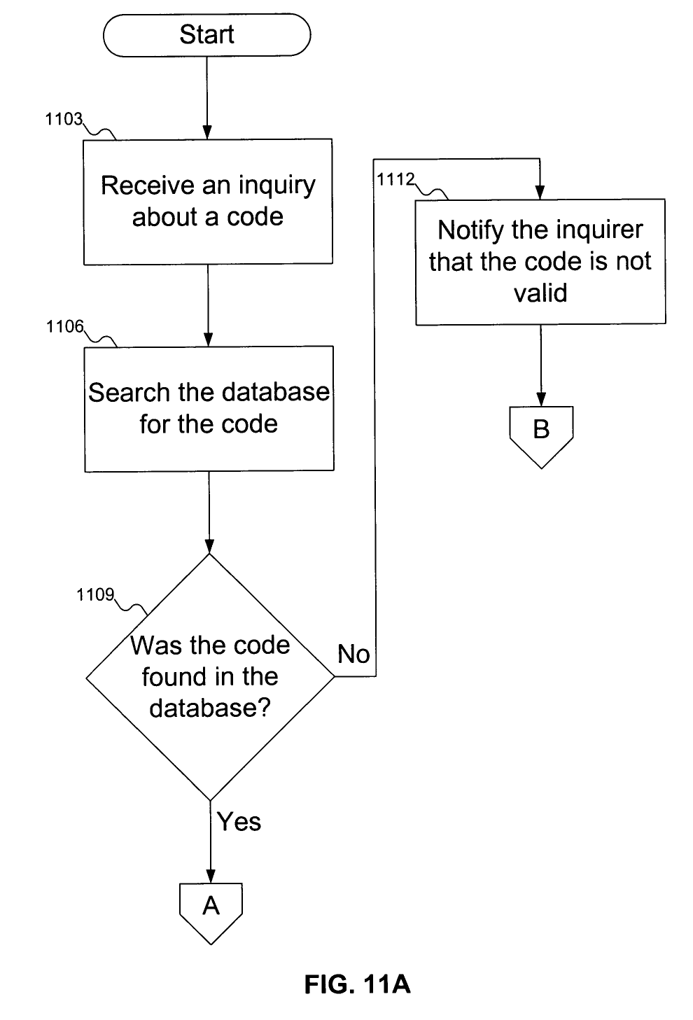

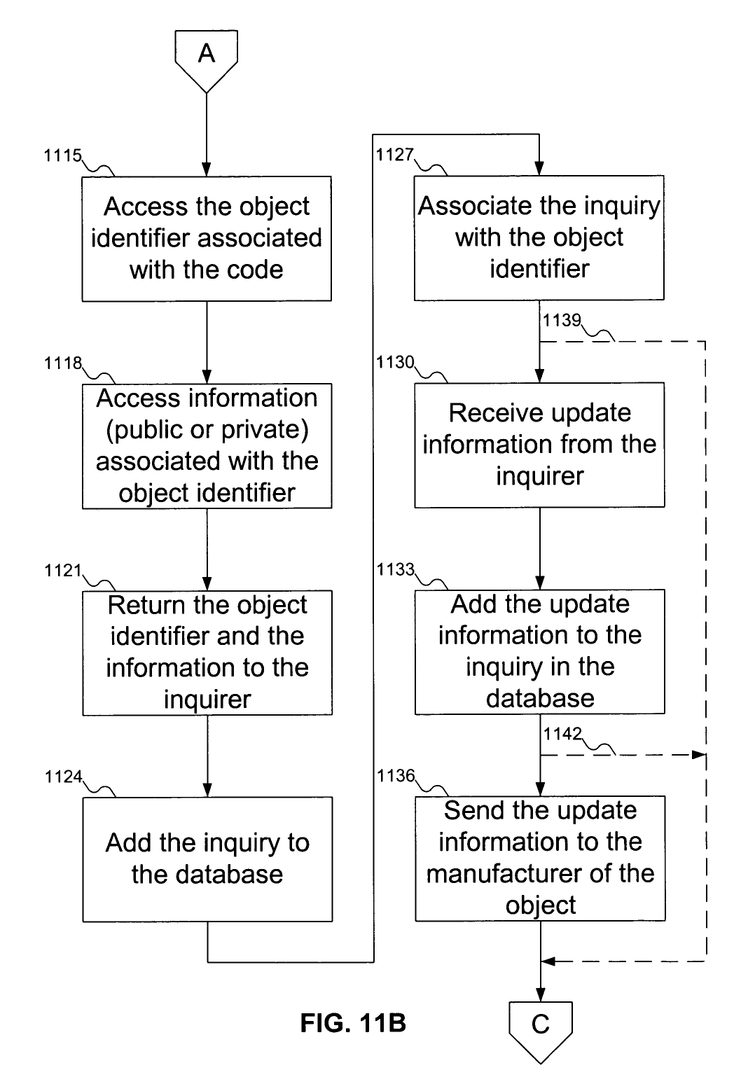

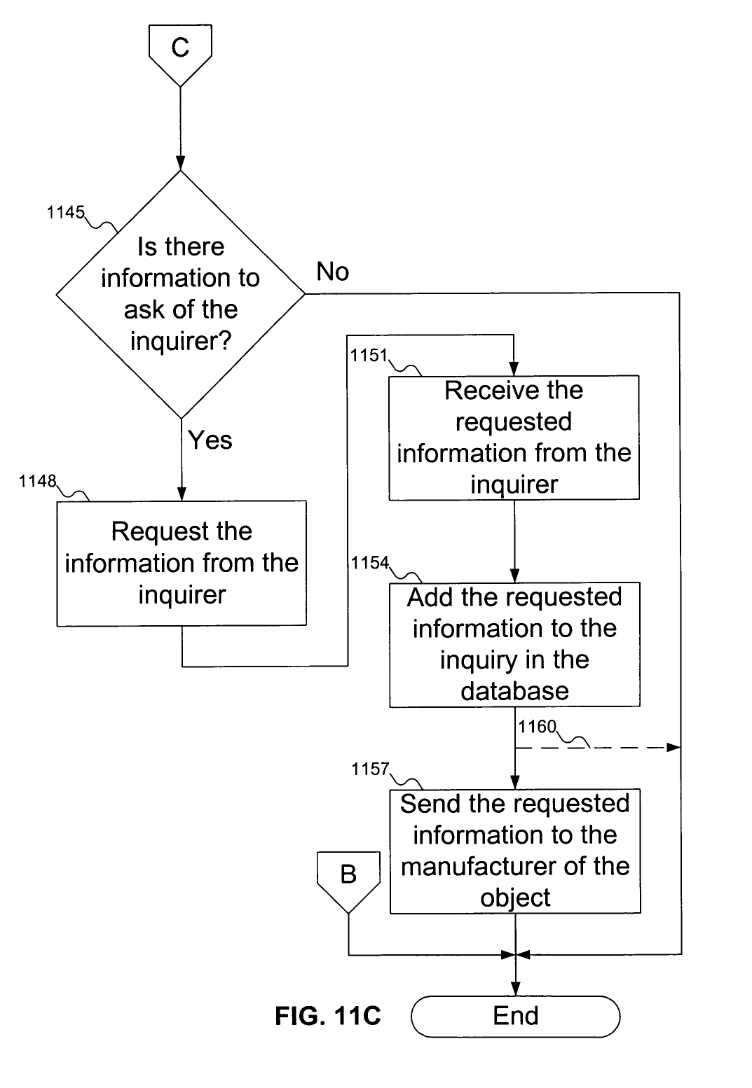

Although FIGS. 10A-10C show one possible ordering of steps, a person skilled in the art will recognize that the steps can be ordered in different ways. The invention is intended to cover all possible variations of FIGS. 10A-10C (along with all possible variations of FIGS. 11A-13B, discussed below).

FIGS. 11A-11C show a flowchart of the procedure used by the computer of FIG. 1 to process an inquiry about a code for an object. In FIG. 11A, at step 1103, the service receives an inquiry about a code. At step 1106, the service searches the database for the code. At step 1109, the service checks whether the code was found in the database. If not, then at step 1112 the service notifies the inquirer that the code was not valid.

If the code was found in the database, then at step 1115 (FIG. 11B) the service accesses the object identifier associated with the code in the database. At step 1118, the service accesses public or private information associated with the object identifier. As discussed above with reference to FIGS. 7-8, all inquirers can access the public information about the object, but only authorized inquirers can access the private information. At step 1121, the information and the object identifier are returned to the inquirer. At step 1124, the service adds the inquiry to the database (using the code for the object tagged with an inquiry number). At step 1127, the service associates the inquiry with the object identifier in the database.

At step 1130, the service receives update information from the inquirer. As discussed above with reference to FIG. 8, this can be update information from an authorized updater or general information/query from a member of the general public. At step 1133, this update information is added to the inquiry in the database. At step 1136, the update information is forwarded to the manufacturer of the object. As shown by dashed arrows 1139 and 1142, steps 1130-1136, or just step 1136, can be skipped.

At step 1145 (FIG. 11C), the service checks whether there is information to ask of the inquirer (for example, a form the manufacturer would like the customer to complete). If there is information to ask of the inquirer, then at step 1148 the information is requested of the inquirer. At step 1151, the requested information is received from the inquirer, and at step 1154 the requested information is added to the inquiry in the database. Finally, at step 1157, the requested information is forwarded to the manufacturer of the object. As shown by dashed arrow 1160, step 1157 can be skipped.

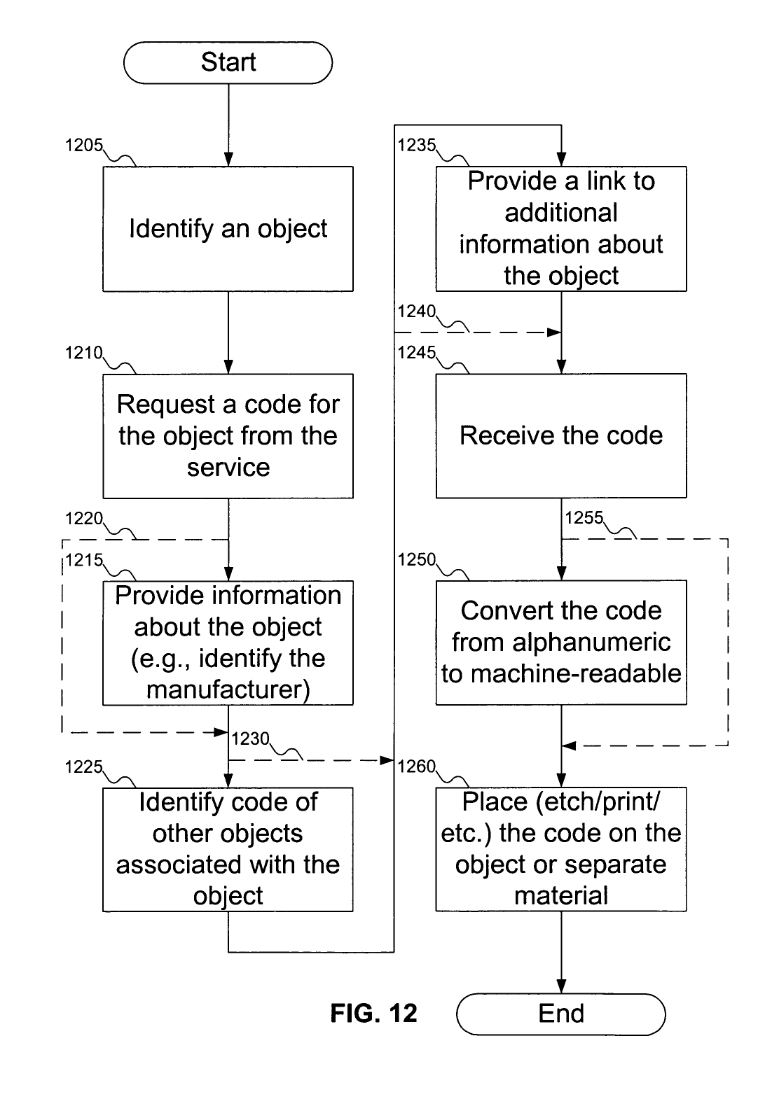

FIG. 12 shows a flowchart of the procedure used by a client of the computer of FIG. 1 to request a code for an object. At step 1205, the manufacturer identifies an object. At step 1210, the manufacturer requests a code for the object from the service. At step 1215, the manufacturer provides information about the object (such as the manufacturer's identity or other information). As shown by dashed arrow 1220, step 1215 can be skipped. At step 1225, the manufacturer identifies codes of other objects that are associated with the object in question. As shown by dashed arrow 1230, step 1225 can be skipped. At step 1235, the manufacturer provides a link to additional information about the object (such a form or information about the object stored outside the service). As shown by dashed arrow 1240, step 1235 can be skipped.

At step 1245, the manufacturer receives the code from the service. At step 1250, the manufacturer converts the code from alphanumeric to machine-readable. As shown by dashed arrow 1255, step 1250 can be skipped. Finally, at step 1260, the manufacturer places the code on the object or on some separate material included with the object.

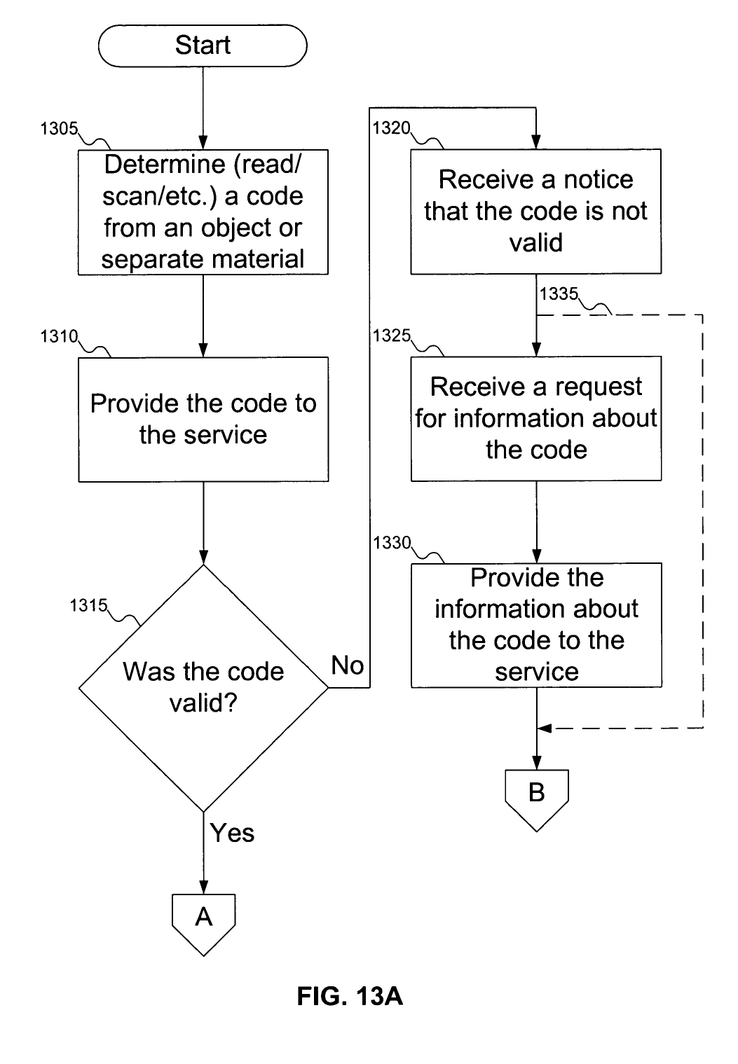

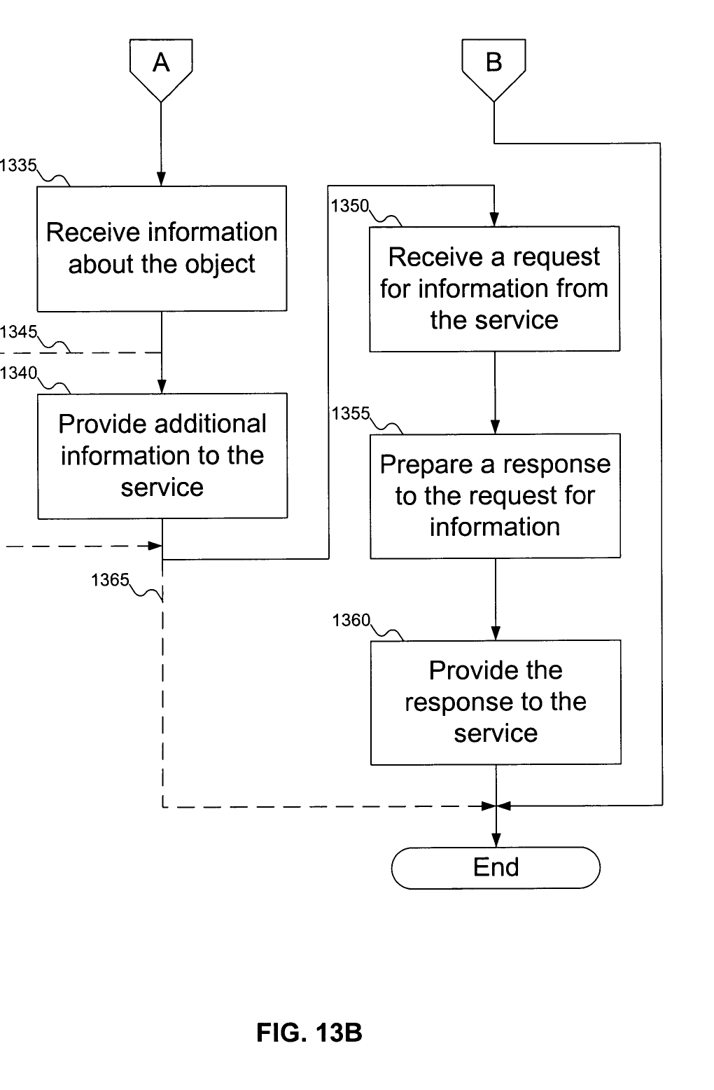

FIGS. 13A-13B show a flowchart of the procedure used by a customer to inquire from the computer of FIG. 1 about a code for an object. In FIG. 13A, at step 1305, the inquirer determines a code for the object, either from the object itself or from material included with the object. At step 1310, the inquirer provides the code to the service. At step 1315, the service determines whether the code is valid. If not, then at step 1320 the inquirer receives a notice that the code is not valid. At step 1325, the inquirer receives a request for information about the code (such as from where the inquirer received the code), and at step 1330, the inquirer provides the information to the service.

If the code is valid, then at step 1335 (FIG. 13B), the inquirer receives information about the object from the service. At step 1340, the inquirer provides additional information (such as update information or general comments/queries) to the service. As shown by dashed arrow 1345, step 1340 can be skipped.

At step 1350, the inquirer receives a request for information from the service. At step 1355, the inquirer prepares a response to the request for information, and at step 1360 the inquirer provides the response to the service. As shown by dashed arrow 1365, steps 1350-1360 can be skipped.

A person skilled in the art will recognize that an embodiment of the invention described above can be implemented using a computer. In that case, the method is embodied as instructions that make up a program. The program may be stored on computer-readable media, such as floppy disks, optical discs (such as compact discs), or fixed disks (such as hard drives), and can be resident in memory, such as random access memory (RAM), read-only memory (ROM), firmware, or flash RAM memory. The program as software can then be executed on a computer to implement the method. The program, or portions of its execution, can be distributed over multiple computers in a network.

Having illustrated and described the principles of the invention in a preferred embodiment thereof, it should be readily apparent to those skilled in the art that the invention can be modified in arrangement and detail without departing from such principles. All modifications coming within the spirit and scope of the accompanying claims are claimed.

1. An apparatus, comprising:
a receiver operative to receive an object identifier;
a code generator to generate a code;
a database operative to associate the code with the object identifier; and
a transmitter operative to transmit the code.

2. An apparatus according to claim 1, wherein:
the receiver is operative to receive information about the object; and
the database is operative to associate the information with the object identifier.

3. An apparatus according to claim 1, wherein the code generator includes a random number generator.

4. An apparatus according to claim 1, wherein the code generator is operative to generate base-35 codes.

5. An apparatus according to claim 1, wherein the code generator is operative to generate alphanumeric codes.

6. An apparatus according to claim 1, further comprising a verifier operative to verify that a request to generate the code comes from a manufacturer of an object identified by the object identifier.

7. An apparatus according to claim 1, further comprising a code comparator to compare the code with a second code in the database.

8. An apparatus according to claim 1, further comprising a computer including the receiver, the code generator, the database, and the transmitter.

9. An apparatus, comprising:
a database including at least a first code associated with a first object identifier and a first information about an object identified by the object identifier;
a receiver operative to receive an inquiry about a second code;
a code comparator to compare the second code with the first code; and
a transmitter operative to transmit the first information associated with the first object identifier if the second code matches the first code.

10. An apparatus according to claim 9, wherein:
the apparatus further comprises a notice indicating that the second code is not valid; and
the transmitter is operative to transmit the notice if the second code does not match the first code.

11. An apparatus according to claim 9, wherein the database is operative to associate the inquiry with the first object identifier if the second code matches the first code.

12. An apparatus according to claim 9, wherein:
the receiver is operative to receive additional information; and
the database is operative to associate the additional information with the first object identifier if the second code matches the first code.

13. A system, comprising:
a receiver operative to receive from a requester: a request for a code for an object identified by an object identifier; and an information about the object;
a code generator to generate the code;
a database operative to associate the code with the object identifier and to associate the information with the object identifier;
a verifier operative to verify that the requester is a manufacturer of the object;
a code comparator to compare the code with a second code in the database;
a transmitter operative to transmit the code to the requester;
means for placing the code on the an object identified by the object identifier;
means for searching the database for the code responsive to an inquiry about the code from an inquirer, the inquiry received by the receiver; and
means for retrieving the information associated with the object identifier from the database, the information transmitted by the transmitter to the inquirer.

14. A computer-implemented method for using a code, comprising:
receiving a request for a code, the request including an object identifier;
generating the code;
adding the object identifier to a database;
associating the code with the object identifier in the database; and
responding to the request with the code.

15. A method according to claim 14, wherein generating the code includes determining whether the code is already associated with a second object identifier in the database.

16. A method according to claim 15, wherein generating the code further includes generating a second code if the code is already associated with the second object identifier in the database.

17. A method according to claim 14, wherein generating the code includes randomly generating the code.

18. A method according to claim 17, wherein generating the code includes using a random number generator to randomly generate the code.

19. A method according to claim 14, wherein generating the code includes generating an alphanumeric code.

20. A method according to claim 14, wherein generating the code includes generating an base-35 code.

21. A method according to claim 14, wherein:
receiving a request includes receiving a manufacturer identifier; and
associating the code with the object identifier includes associating the manufacturer identifier with the object identifier.

22. A method according to claim 14, further comprising verifying that a manufacturer of an object identified by the object identifier made the request.

23. A method according to claim 22, wherein verifying that a manufacturer of an object identified by the object identifier made the request includes requesting the manufacturer to verify that it made the request.

24. A method according to claim 22, wherein:
receiving a request includes receiving a manufacturer code associated with the manufacturer; and
verifying that a manufacturer of an object identified by the object identifier made the request includes searching the database to determine if the manufacturer code is associated with an identifier of the manufacturer.

25. A method according to claim 24, wherein verifying that a manufacturer of an object identified by the object identifier made the request further includes, if the manufacturer code is not associated with the identifier of the manufacturer, sending a message to the manufacturer.

26. A method according to claim 14, wherein:
receiving a request includes receiving information; and
the method further includes associating the information with the object identifier.

27. A method according to claim 26, wherein:
receiving information includes receiving a question; and
associating the information includes associating the question with the object identifier.

28. A computer-implemented method for using a code, comprising:
receiving an inquiry from a requester, the inquiry including the code;
searching a database to determine if the code is associated with an object identifier in the database; and
if the code is associated with an object identifier:
accessing information associated with the object identifier; and
returning the information to the requester.

29. A method according to claim 28, further comprising receiving update information from the requester.

30. A method according to claim 29, further comprising associating the update information with the object identifier in the database.

31. A method according to claim 29, further comprising sending the update information to a manufacturer identified by a manufacturer identifier associated with the object identifier.

32. A method according to claim 28, further comprising, if the code is not associated with an object identifier, returning to the requester a notice that the code is not valid.

33. A method according to claim 32, further comprising:
requesting additional information from the requester; and
receiving the additional information from the requester.

34. A method according to claim 33, further comprising sending the additional information to a manufacturer identified by a manufacturer identifier associated with the object identifier.

35. A method according to claim 28, further comprising associating the request with the object identifier.

36. A computer-implemented method for using a code, comprising:
identifying an object;
requesting a code for the object from a computer, the request including an object identifier for the object;
receiving the code for the object; and
placing the code on the object.

37. A method according to claim 36, wherein placing the code on the object includes printing the code on the object.

38. A method according to claim 36, wherein placing the code on the object includes etching the code on the object.

39. A method according to claim 38, wherein etching the code includes etching the code on the object using a laser.

40. A method according to claim 36, wherein placing the code on the object includes printing the code on a material separate from but included with the object.

41. A method according to claim 36, wherein requesting a code includes providing information about the object to the computer.

42. A method according to claim 41, wherein providing information includes providing an identifier for a manufacturer of the object.

43. A method according to claim 41, wherein providing information includes providing a second code associated with a second object.

44. A method according to claim 41, wherein providing information includes providing a hyperlink that can be used to access additional information about the object.

45. A method according to claim 36, wherein:
receiving the code includes receiving an alphanumeric code; and
the method further comprises converting the alphanumeric code to a machine-readable code.

46. A computer-implemented method for using a code, comprising:
determining a code from an object;
providing the code to a computer; and
receiving information from the computer concerning an object identified by an object identifier associated with the code.

47. A method according to claim 46, wherein:
receiving information includes receiving a question from the computer; and
the method further comprises:
preparing a response to the question; and
providing the response to the computer.

48. A method according to claim 46, wherein:
receiving information includes receiving a hyperlink that can be used to access additional information about the object; and
the method further comprises using the hyperlink to access the additional information.

49. A method according to claim 46, further comprising providing additional information to the computer.

50. A method according to claim 46, wherein providing the code includes scanning the code using a machine.

51. A method according to claim 46, wherein determining a code includes reading the code from the object.

52. A method according to claim 46, wherein determining a code includes determining the code from a material separate from but included with the object.

53. A method according to claim 46, wherein receiving information from the computer includes receiving a notice from the computer that the code is not valid:

54. A method according to claim 53, further comprising:
receiving a request for information about the code from the computer; and
providing the information about the code to the computer.

55. A computer-implemented method for using a code, comprising:
identifying an object by a manufacturer;
requesting a code for the object from a computer by the manufacturer, the request including an object identifier for the object and an information about the object;
receiving the code for the object by the manufacturer; and
placing the code on the object by the manufacturer;
delivering the object by the manufacturer to an inquirer;
determining the code from the object by the inquirer;
providing the code to the computer by the inquirer; and
receiving the information about the object from the computer by the inquirer.

56. Computer-readable medium containing a program to use a code, comprising:
software to receive a request for a code, the request including an object identifier;
software to generate the code;
software to add the object identifier to a database;
software to associate the code with the object identifier in the database; and
software to respond to the request with the code.

57. Computer-readable medium containing a program to use a code, comprising:
software to receive an inquiry from a requester, the inquiry including the code;
software to search a database to determine if the code is associated with an object identifier in the database; and
if the code is associated with an object identifier:
software to access information associated with the object identifier; and
software to return the information to the requester.

58. Computer-readable medium containing a program to use a code, comprising:
software to identify an object;
software to request a code for the object from a computer, the request including an object identifier for the object;
software to receive the code for the object; and
software to place the code on the object.

59. Computer-readable medium containing a program to use a code, comprising:
software to determine a code from an object;
software to provide the code to a computer; and
software to receive information from the computer concerning an object identified by an object identifier associated with the code.
